(19) United States
(12) Patent Application Publication
(10) Pub. No.: US 2019/0313574 A1
(43) Pub. Date: Oct. 17, 2019

(54) FERTILIZING SYSTEM FOR AGRICULTURAL SOILS, METHOD FOR OPERATING A FERTILIZING SYSTEM

(71) Applicant: Robert Bosch GmbH, Stuttgart (DE)

(72) Inventors: Johanna Link-Dolezal, Denkendorf (DE); Jochen Fehse, Friolzheim (DE); Boris Buchtala, Muehlacker (DE); Tillmann Falck, Stuttgart (DE)

(21) Appl. No.: 16/471,896

(22) PCT Filed: Dec. 19, 2017
(86) PCT No.: PCT/EP2017/083485

§ 371 Date: Jun. 20, 2019

(30) Foreign Application Priority Data
Dec. 29, 2016 (DE) 10 2016 226 292.0

(51) Int. Cl. A01C 21/00

(52) U.S. Cl. CPC A01C 21/007; A01C 21/005

(57) ABSTRACT

A fertilizing system for agricultural soils includes an application device for applying fertilizer and including a test device for detecting a nitrous oxide content in or on the agricultural soil to be fertilized. The test device includes multiple nitrous oxide sensors including in each case a first transmission device for transmitting measuring data, and including a data processing device that includes a first receiving device for receiving the measuring data.

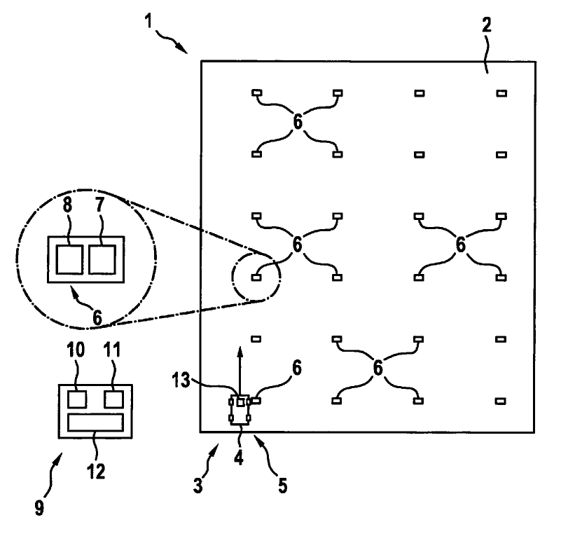

### CROSS-REFERENCE TO RELATED APPLICATIONS

The present application is the national stage of International Pat. App. No. PCT/EP2017/083485 filed Dec. 19, 2017, and claims priority under 35 U.S.C. § 119 to DE 10 2016 226 292.0, filed in the Federal Republic of Germany on Dec. 29, 2016, the content of each of which are incorporated herein by reference in their entireties.

### FIELD OF THE INVENTION

The present invention relates to a fertilizing system for agricultural soils, having an application device for applying fertilizer and having a test device for detecting a nitrous oxide content in or on the agricultural soil to be fertilized. Furthermore, the present invention relates to a method for operating a fertilizing system of this type.

### BACKGROUND

In order to increase harvest yields and/or to ensure a desired quality of the yield, it is known to provide agricultural soils with fertilizer. In agricultural production, nitrogenous fertilizers, like ammonium and/or nitrate-based fertilizers, are often used in the process. These fertilizers can be transformed through microbial conversion processes, such as nitrification and denitrification, in the soil into nitrous oxide (N₂O). The efficiency of the fertilizer use thereby lies at best at 50%, which means that approximately only half of the nitrogen applied can actually be used by the plants. The rest is lost and ends up in the atmosphere as nitrous oxide, among other things. Land used in agriculture (agricultural soils) is/are thus a significant source for nitrous oxide emissions. Nitrous oxide itself is known as a harmful greenhouse gas. The formation of nitrous oxide is particularly dependent on additional soil parameters, for example, mineralized nitrogen or organically bound carbon, the proportion of pore space filled with water, the temperature, and the pH value of the soil, in addition to the fertilizer amount applied and fertilizer type, and is subject to complex interactions.

### SUMMARY

According to an example embodiment of the present invention, a fertilizing system is provided which has an advantage that changes in nitrous oxide emissions from the agricultural soil are automatically detected and can be taken into account in the fertilizer management under consideration of complex interactions within the agricultural soil or field. The present invention provides for this purpose that the fertilizing system has multiple nitrous oxide sensors including in each case a first transmission device for transmitting measuring data, and a data processing device which has a first receiving device for receiving the measuring data that were transmitted by the respective first transmission device. Thus, it is achieved that the nitrous oxide content is detected or monitored at multiple points in the agricultural soil and is provided to a central data processing device, which determines, for example, the fertilizer need and/or the type of fertilizer based on the detected values. Thus, an advantageous fertilization of the agricultural soil is ensured, which also considers influences damaging to the climate.

According to an example embodiment of the present invention, the data processing device is configured to determine a fertilizer amount to be applied based on the received measuring data. It is additionally achieved that the fertilizer amount and optionally the type of fertilizer are optimally adapted to the state of the agricultural soil.

In addition, the data processing device preferably includes at least one second transmission device for transmitting measuring data or the determined fertilizer amount, and the application device has a second receiving device to receive the measuring data or the determined fertilizer amount. Thus, the application device receives either data about the nitrous oxide content in the soil, and then decides about the fertilizer amount to be applied using an algorithm, or it already receives the already pre-packaged piece of information about the fertilizer amount to be applied from the data processing device.

In addition, the nitrous oxide sensors are preferably configured as infrared gas sensors. These types of gas sensors are, for example, already known for use in detecting carbon dioxide in motor vehicles. To be used as nitrous oxide sensors, the filter of the sensors is preferably adjusted in the near infrared range for nitrous oxide detection.

In addition, the first transmission devices are preferably configured to transmit position data, which relate to the respective nitrous oxide sensor, in addition to the measuring data. Thus, the data processing device basically receives not only the piece of information about the nitrous oxide content, but also at the same time the piece of information about where this nitrous oxide content was traced. Alternatively, the respective nitrous oxide sensor transmits an identification number or designation and the data processing device links the identification of the respective nitrous oxide sensor to a position assigned to this sensor, which can have been previously entered, for example, manually or automatically when setting the respective nitrous oxide sensor.

In addition, the device is preferably configured as a self-driving fertilizer device that autonomously applies the fertilizer based on the determined fertilizer amount(s) and the position data. Thus, an automated fertilizing operation is ensured by the fertilizing system which takes the nitrous oxide content in the soil into consideration. Alternatively, the device is configured as a drawn or pullable fertilizer device, for example as a trailer for a tractor.

In addition, the data processing device is preferably configured as a local control unit or a central data center in order to process the data from multiple fertilizing systems. In the configuration as a local control unit, the data processing device is thus situated, for example, on the application device itself, and thus controls this locally. Alternatively, the data processing unit is situated locally on the field or assigned to the field and is responsible only for the one fertilizing system. According to a second example embodiment, the data processing operates centrally for multiple fertilizing systems, and thus, for example, bundles the computing power. Thus, for example, the central data processing system can be configured to evaluate the nitrous oxide content and the respective interactions, which occur in the respective agricultural soil, and to correspondingly determine the fertilizer amount for the respective field or fertilizing system using supercomputers. Because calculations of this type are relatively complex, cost reductions are possible by outsourcing the calculation to a central system for multiple users of a corresponding fertilizing system, without disadvantages when applying the fertilizer.

In addition, it is provided that the data processing unit is preferably configured to store the detected measuring data and optionally the determined fertilizer amounts based on the sensor position and optionally to take the stored information into account when determining an instantaneous fertilizer amount. Thus, it is achieved, for example, that the fertilization of the agricultural soil is tracked and archived over a longer time period, so that the fertilizing strategy or the determination of the fertilizer to be applied can be adapted using knowledge of the fertilizer already present in the agricultural soil in order to achieve optimal fertilization.

According to an example embodiment of the present invention, a method includes detecting nitrous oxide content in the agricultural soil using the nitrous oxide sensors at different points in the agricultural soil and determining one or multiple fertilizer amounts for the agricultural soil from the detected values, in particular based on the position of the respective nitrous oxide sensors. The previously mentioned advantages arise from this.

In particular, the application device is controlled to apply the determined fertilizer amount in a semi or fully automated manner. Thus, it is ensured that the optimal fertilizer amount reaches the agricultural soil.

Additional advantages and preferred features and feature combinations arise in particular from the previous description and from the claims. The present invention is subsequently explained in greater detail with reference to the drawing.

### BRIEF DESCRIPTION OF THE DRAWINGS

The FIGURE shows an agricultural field including a fertilizing system according to an example embodiment of the present invention.

### DETAILED DESCRIPTION

The FIGURE shows in a simplified top view an agricultural field 1, which includes agricultural soil 2 on which crop plants are planted. A fertilizing system 3, which has a drivable application device 4, for example a tractor, and a test device 5, is assigned to agricultural field 1. Application device 4 is configured to distribute in particular granular or liquid fertilizer onto agricultural field 1. Test device 5 is configured to detect a nitrous oxide content in agricultural soil 2. For this purpose, test device 5 includes multiple nitrous oxide sensors 6 distributed across the field in the form of a matrix. For the sake of clarity, only some of nitrous oxide sensors 6 are provided with reference numerals.

Nitrous oxide sensors 6 essentially correspond in their design to the design of known carbon dioxide sensors, but have a difference in that their filter is adapted to detect nitrous oxide in the near infrared range and the sensor system is adapted for use in agricultural soils. Nitrous oxide sensors 6 each include, in addition to the actual sensors 7 for detecting nitrous oxide, an additional transmission device 8. This is configured to transmit the nitrous oxide concentration in the agricultural soil detected by nitrous oxide sensor 6 to a data processing device 9 of test device 5. Data processing device 9 is designed as a local data processing and includes a receiving unit 10 for receiving measuring data measured by nitrous oxide sensors 6. Using a processing unit 11, data processing device 9 determines a fertilizer amount to be applied by the application device 4 based on the received measuring data based on the position of application device 4 on field 1.

Nitrous oxide sensors 6 additionally transmit, together with the respective measuring data, an identification and optionally also a position of respective nitrous oxide sensor 6 so that data processing device 9 can respectively assign the measuring data received to one of nitrous oxide sensors 6. With knowledge of the arrangement of nitrous oxide sensors 6, a nitrous oxide map can thus be generated, in which the nitrous oxide content or the nitrous oxide distribution of agricultural soil 2 is determined within field 1. The instantaneous position of application device 4 is continuously ascertained, in particular by a satellite-supported navigation system.

With knowledge of the instantaneous position of application device 4, the dispensed fertilizer amount is now predetermined based on the respective concentration of nitrous oxide prevailing in agricultural soil 2, the complex interactions within agricultural soil 2 and the nutritional requirement of the cultivated crop being considered in the determination of the fertilizer amount. Data processing device 9 in this case communicates with application device 4 using a second transmission device 12 and a receiving device 13 assigned to application device 4. Data processing 9 in this case transmits either the detected measuring data from nitrous oxide sensors 6 or the already predetermined fertilizer amount to receiving device 13. Device 4, which moves across field 1, then dispenses the predetermined fertilizer amount at the previously determined point onto agricultural soil 2.

The nitrous oxide sensors detect a change of the nitrous oxide content in the agricultural soil or in the air close to the ground over a longer period of time, the changes being preferably stored by data processing device 9 in a type of data logger in order to map the chronological and spatial progression of the nitrous oxide emissions of field 1. Optionally, the transmitted data are additionally transmitted to a central data processing or to a cloud service and stored there. The calculation of a needs-based fertilizer amount for field 1 takes place here under consideration of the measured nitrous oxide emissions and the known interactions. The fertilizer recommendation is transmitted to the onboard computer or to a control unit of application device 4, for example, by data processing device 9, which controls application device 4 to spread or spray the fertilizer according to need.

According to an example embodiment, it is provided that additional information is provided about the previous fertilizer management of field 1, for example, historic data or available data from Internet services flow into the calculation of a needs-based fertilizer amount. Furthermore, according to an example embodiment, the actually applied fertilizer amount is recorded by application device 4 and transmitted to data processing 9 or to the cloud service in order to document the fertilizer management of field 1.

1-10. (canceled)

11. A fertilizing system comprising:
a fertilizer applicator; and
a tester, wherein the tester includes
a plurality of nitrous oxide sensors that each is configured to detect a nitrous oxide content in or on agricultural soil to be fertilized by application of fertilizer by the applicator and that each has a first transmitter, the transmitter being configured to transmit measuring data detected by the respective sensor; and
a data processing device that includes a first receiver for receiving the measuring data.

12. The fertilizing system of claim 11, wherein the data processing device is configured to determine an amount of the fertilizer to be applied by the applicator based on the received measuring data.

13. The fertilizing system of claim 11, wherein the data processing device includes at least one second transmission device for transmitting measuring data or a determined fertilizer amount, and the applicator includes a second receiver for receipt of the measuring data or the determined fertilizer amount.

14. The fertilizing system of claim 11, wherein the nitrous oxide sensors are infrared gas sensors.

15. The fertilizing system of claim 11, wherein the first transmitter is configured to additionally transmit position data that relate to the respective nitrous oxide sensor.

16. The fertilizing system of claim 11, wherein the applicator is a self-driving fertilizing device and is configured to autonomously apply the fertilizer based on the determined fertilizer amount and the position data.

17. The fertilizing system of claim 11, wherein the data processing device is a central data center configured to process data from multiple fertilizing systems.

18. The fertilizing system of claim 11, wherein the data processing device is configured to store the detected measuring data as a function of the position data.

19. The fertilizing system of claim 18, wherein the data processing device is configured to determine an amount of the fertilizer to be applied by the applicator based on the stored measuring data.

20. The fertilizing system of claim 18, wherein the data processing device is configured to store determined or applied fertilizer amounts as a function of the position data.

21. The fertilizing system of claim 20, wherein the data processing device is configured to determine a new amount of fertilizer to be applied based on the stored measuring data.

22. A method for operating a fertilizing system that includes a fertilizer applicator and a tester, wherein the tester includes (a) a plurality of nitrous oxide sensors that each has a first transmitter, and (b) a data processing device that includes a first receiver, the method comprising:
the nitrous oxide detecting a nitrous oxide content in or on a plurality of points of the agricultural soil to be fertilized by application of fertilizer by the applicator, wherein the transmitter is configured to transmit measuring data detected by the respective sensor and the first receiver is configured for receiving the transmitted measuring data;
the data processing device determining one or more fertilizer amounts for the agricultural soil based on the measuring data.

23. The method of claim 22, wherein the determination of the one or more fertilizer amounts is based on the respective positions of the respective nitrous oxide sensor.

24. The method of claim 22, further comprising controlling the applicator to apply the determined fertilizer amount in a semi or fully automated manner.
